(19) United States
(12) Patent Application Publication
(10) Pub. No.: US 2003/0232163 A1
(43) Pub. Date: Dec. 18, 2003

(54) Wire loom

(76) Inventors: Craig Jay Graham, Eastman, GA (US); Nobuo Fujisawa, Macon, GA (US); Joel William Pfeil, Dry Branch, GA (US)

Correspondence Address: JOHN ALEXANDER GALBREATH, 2516 CHESTNUT WOODS CT, REISTERSTOWN, MD, 21136, US

(21) Appl. No.: 10/174,009

(22) Filed: Jun. 17, 2002

(51) Int. Cl. B32B 1/08; B32B 3/04; F16L 3/00

(52) U.S. Cl. 428/36.1; 428/99; 428/100

(57) ABSTRACT

The invention is a wire loom constructed from a strip of plastic hook fastener material, which holds a single wire or cable in position, or a bundle of wires or cables together. The wire loom is formed by stretching the hook fastener material along its lengthwise dimension, and has a curled center portion forming a tubular channel in which wires or cable are inserted and retained, and two uncurled end portions. The hook layer side of the loom can be secured to a strip or patch of mating loop material located on a panel, frame member, or other object, to hold the wires or cable in a desired position. An additional strip of loop material may be wrapped around the center of the loom or placed longitudinally on the loom for extra wire-retaining strength.

### CROSS-REFERENCES TO RELATED APPLICATIONS

Not applicable.

### BACKGROUND

1. Field of the Invention

This invention is in the area of wire looms which hold a single wire or cable in position, or a bundle of wires or cables together, specifically a wire loom constructed from a length of extruded hook fastener material.

2. Description of the Related Art

Various wire and cable looms or sleeves are disclosed in the prior art. U.S. Pat. No. 4,784,886 to Monget et al. discloses a wire sleeve with a natural transverse curl which acts to hold the sleeve in a wrapped position. U.S. Pat. No. 4,891,256 to Kite et al.; U.S. Pat. Nos. 5,178,923 to Andrieu et al.; and 5,300,337 also to Andrieu et al., disclose devices similar to that of U.S. Pat. No. 4,784,886, and are further described below:

U.S. Pat. No. 4,891,256 discloses a wraparound wire sheath made from a fabric of engineering plastic filaments, and a method of making such a sheath. The sheath is split along its length, and has fasteners attached to the mating edges in order to hold the sheath together once the wires have been placed in it. U.S. Pat. Nos. 5,178,923 and 5,300,337 closely resemble each other. Each discloses a woven or knit screen-like fabric with hooks on one edge and bulky yarn interlaced into the opposite edge. When the device is wrapped around a bundle of wires, the hooks engage the bulky yarn to hold the device in place.

U.S. Pat. No. 4,920,235 to Yamaguchi is similar to the above patents. It discloses a woven, screen-like conductive sleeve for fastening together a bundle of cables or wires. This flexible sleeve wraps around the bundle of wires, and one edge has a strip of hooks that engage the screen fabric to hold the sleeve in place. U.S. Pat. No. 5,535,787 to Howell and U.S. Pat. No. 5,901,756 to Goodrich describe flexible sleeves that wrap around a bundle of wires or cables to secure them together. Finally, U.S. Pat. No. 4,640,032 to Lewis discloses a flexible wire loom that separates the enclosed wires from each other.

The above devices exhibit several significant disadvantages, however. First, none have fastening elements on the outer surface of the loom such that the loom can easily be secured to a strip of loop material located on a panel, frame member, or other object. Second, most have no natural “curl” force that holds the device closed around a bundle of wires or cable. Instead, most of these devices employ additional patches or strips of mating hook-and-loop material along corresponding edges of the loom, in order to secure the edges of the loom together. This necessitates additional parts and extra assembly time, resulting in higher cost.

Thus it can be seen that a wire loom which is very simple in design and construction, which can be easily manufactured from a single extruded piece of hook fastener material, which has a natural “curl” force that holds the device closed around a bundle of wires or cable, and which has fastening elements on the outer surface of the loom such that the loom can easily be secured to a strip of mating material located on a panel, frame member, or other object, would be a significant advantage over the prior art.

Accordingly, several objects and advantages of the invention are:

It is simple in design and construction, and can be easily manufactured from a single extruded piece of hook fastener material if desired, at low cost.

It has a natural “curl” force which holds the device closed around a bundle of wires or cable.

It has fastening elements on the outer surface of the loom such that the loom can easily be secured to a strip of mating material located on a panel, frame member, or other object. Thus, the invention is useful for positioning wire or cable in a desired location, as well as for bundling them together.

Further objects and advantages of the invention will become apparent from a consideration of the drawings and ensuing description.

### SUMMARY

This invention is a wire loom constructed from a length of extruded hook fastener material, which holds a single wire or cable in position, or a bundle of wires or cables together.

### DESCRIPTION OF THE DRAWINGS

FIG. 1 is a top view of the hook layer side of the fastener strip, before the strip is stretched to form the wire loom.

FIG. 2 is a top view of the wire loom after the fastener strip has been stretched to form it, showing the back (hook layer) side and showing the curled center portion and the uncurled end portions.

FIG. 3 is a top view of the wire loom after the fastener strip has been stretched to form it, showing the front (non-hook layer) side and showing the curled center portion and the uncurled end portions.

FIG. 4 is a top view of the wire loom with a bundle of wires inserted into place and retained by the loom.

FIG. 5 is a top view of the wire loom with a bundle of wires inserted into place and retained by the loom, and with an additional piece of loop material wrapped around the center of the loom for extra wire-retaining strength.

FIG. 6 is a top view of the wire loom with a bundle of wires inserted into place and retained by the loom, and with an additional piece of loop material positioned longitudinally on the loom for extra wire-retaining strength.

FIG. 7 is a top view of the wire loom after the fastener strip has been stretched to form it, wherein the loom comprises a relatively long, curled center portion without uncurled end portions.

### DETAILED DESCRIPTION OF THE INVENTION

The following provides a list of the reference characters used in the drawings:

| | |
|---|---|
| 10. | Fastener strip |
| 11. | Wire loom |
| 12. | Hooks |
| 13. | Curled center portion |
| 14a&b. | Uncurled end portions |
| 15. | Arcuate ribs |
| 16a,b,&c. | Wires |
| 17. | Loop material |

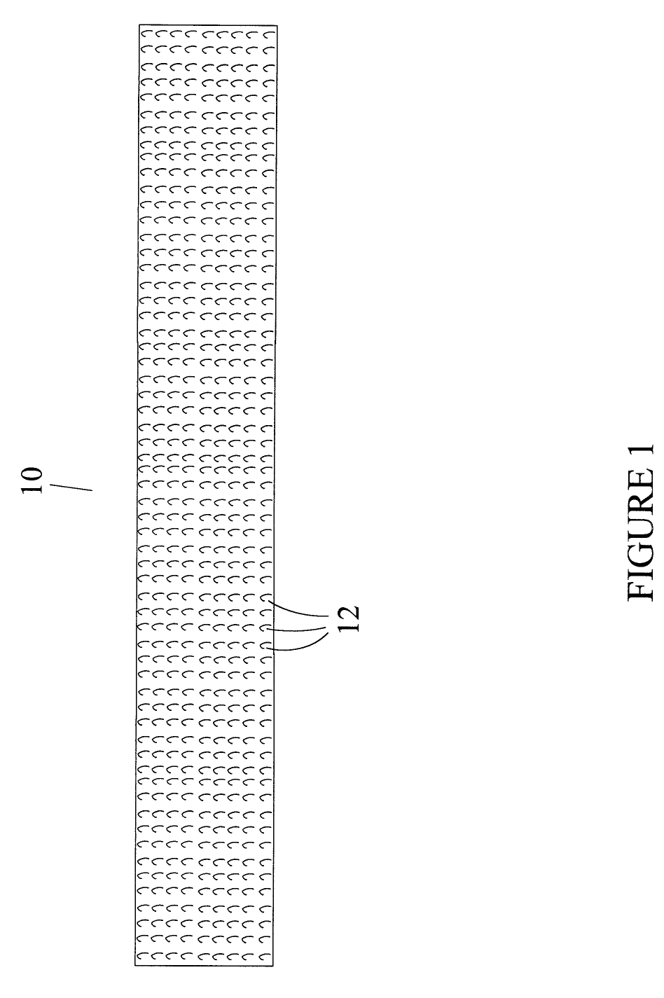

FIG. 1 is a top view of the hook layer side of a fastener strip 10, before fastener strip 10 is stretched to form wire loom 11 of the invention. A plurality of hooks 12 are arrayed in spaced transverse rows across the face of the hook layer. The density of hooks 12 on the face of the hook layer depends on the required performance, but is generally in the range of 1-2000 hooks per square inch. The height of hooks 12 also depends on the required performance; but is generally in the range of 0.1-4.0 millimeters. Fastener strip 10 is constructed of an extruded plastic resin material, using any of the fastener strip extrusion processes known in the prior art.

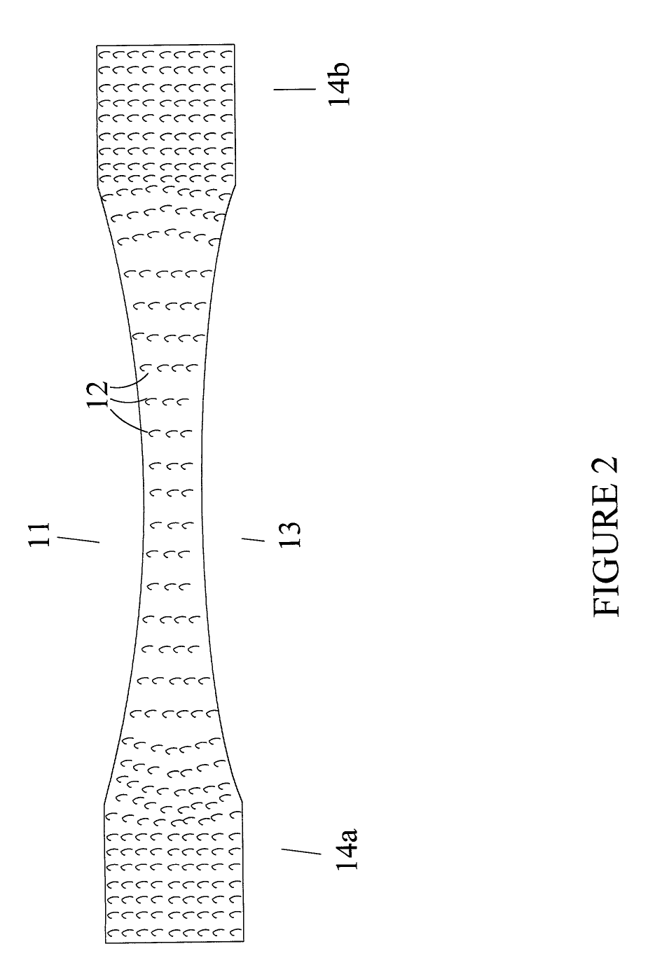

FIG. 2 is a top view of wire loom 11 after fastener strip 10 has been stretched along its lengthwise direction to form the invention, showing the back (hook layer) side and showing the curled center portion 13 and the uncurled end portions 14a&b. It can be seen that upon stretching fastener strip 10 along its lengthwise dimension the rows of hooks 12 in the curled center portion 13 become further spaced apart than the rows of hooks 12 in the uncurled end portions 14a&b.

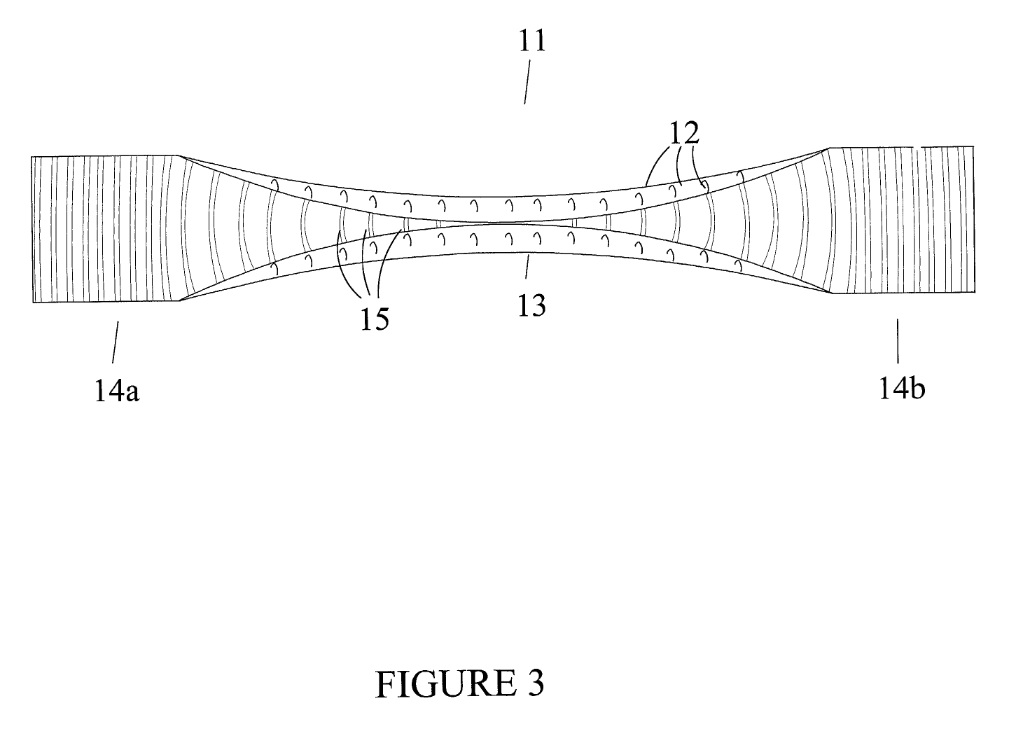

FIG. 3 is a top view of wire loom 11 after fastener strip 10 has been stretched to form it, showing the front (non-hook layer) side and showing the curled center portion 13 and the uncurled end portions 14a&b. Upon stretching fastener strip 10, the rows of hooks 12 in the curled center portion 13 essentially become a series of arcuate ribs 15. Arcuate ribs 15, in combination with the further-apart spacing of the rows of hooks 12 in the curled center portion 13, serve to impart a permanent natural curl to curled center portion 13. The center edges of wire loom 11 come into close proximity with each other, forming a tubular channel in which wire or cable can be positioned and retained.

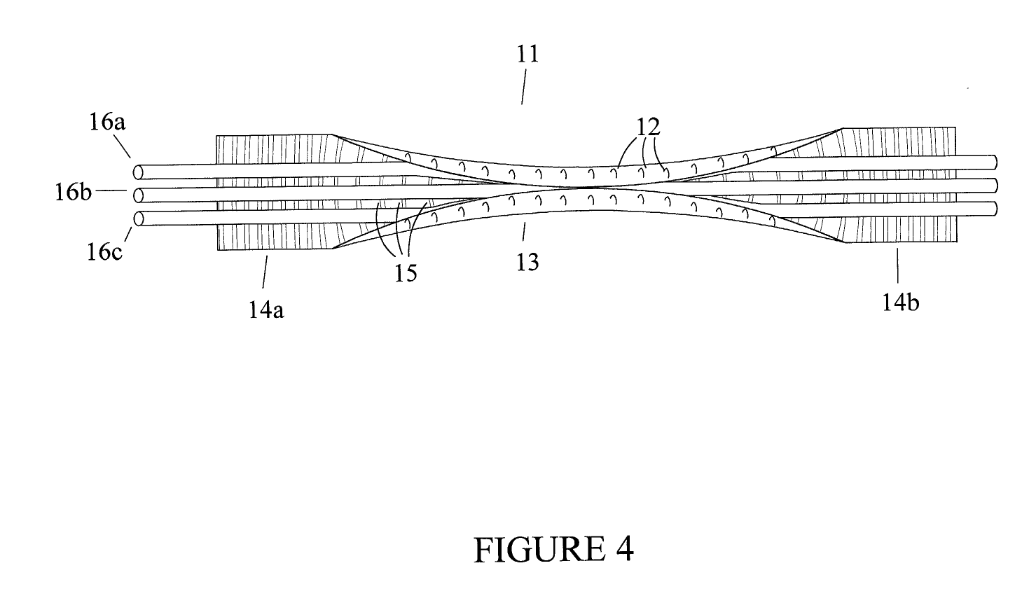

FIG. 4 is a top view of wire loom 11 with a bundle of wires 16a,b,&c inserted into place and retained by wire loom 11. It can be appreciated that the hooks 12 on the back (hook layer side) of wire loom 11, either on the uncurled end portions 14a&b or on the curled center portion 13, can be used to secure wire loom 11 to a strip or patch of loop material. Thus, wire loom 11 is useful for positioning wires 16a,b,&c in a desired location, as well as for bundling them together.

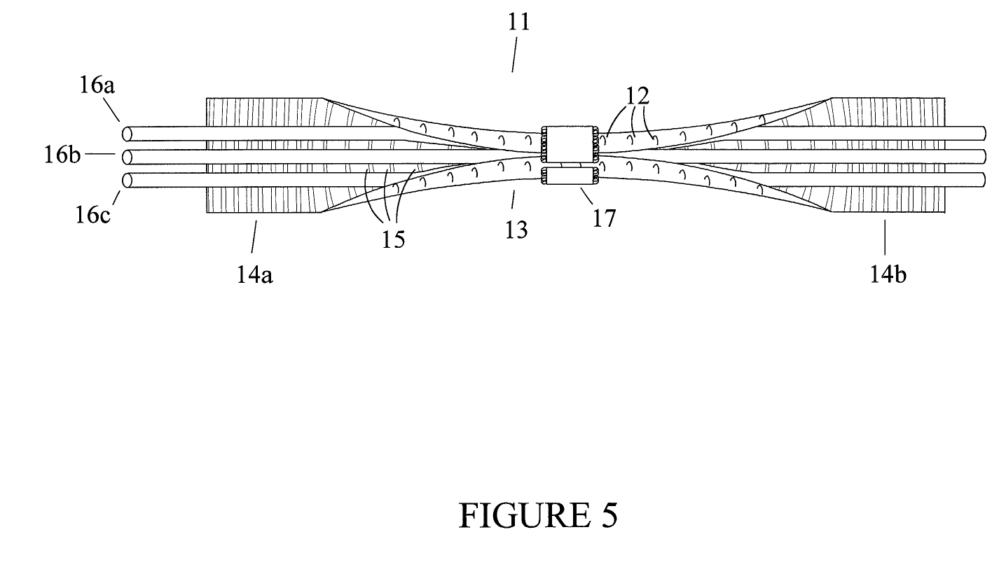

FIG. 5 is a top view of wire loom 11 with a bundle of wires 16a,b&c inserted into place and retained by wire loom 11, and with an additional piece of loop material 17 wrapped around the center of wire loom 11 for extra wire-retaining strength. Loop material 17 is held in place by engagement with hooks 12, said hooks 12 located around the outer circumference of curled center portion 13.

Conclusions, Ramifications, and Scope:

Thus the reader will see that this invention provides a very effective, low-cost way of bundling a plurality of wires or cables together, and holding that bundle or a single wire or cable in position.

While the above descriptions contain many specificities, these shall not be construed as limitations on the scope of the invention, but rather as exemplifications of embodiments thereof. Many other variations are possible. Examples of just a few of the possible variations follow:

The fastening elements can be located on both sides (faces) of the fastener strip. In addition, the fastening elements can be of any shape or type—not just the hooks illustrated in the main embodiment. If the fastening elements are hooks, they can have a mushroom, head-and-stem, seed/leaf, J-hook, spear, or any other suitable shape. All that is required is that they be able to matingly engage with corresponding fastening elements, including but not limited to loop elements and hook elements.

If the fastening elements are hooks, they can formed with the hook portion parallel or perpendicular to the longitudinal dimension of the wire loom, or at any suitable angle to the aforementioned parallel or perpendicular orientation.

The fastener strip which is stretched to form the wire loom can be made by processes other than the extrusion process discussed earlier. As just two examples, the fastener strip can also be made by continuous injection, or by forcing a thermoplastic polymer sheet between a pressing roller and a hook shaping roller.

The uncurled end portions are useful for positioning the bundled wires or single wire in a desired location, using the hooks on the back of the uncurled end portions—but these uncurled end portions are not absolutely necessary, and one or both can be eliminated. In one such embodiment, illustrated in

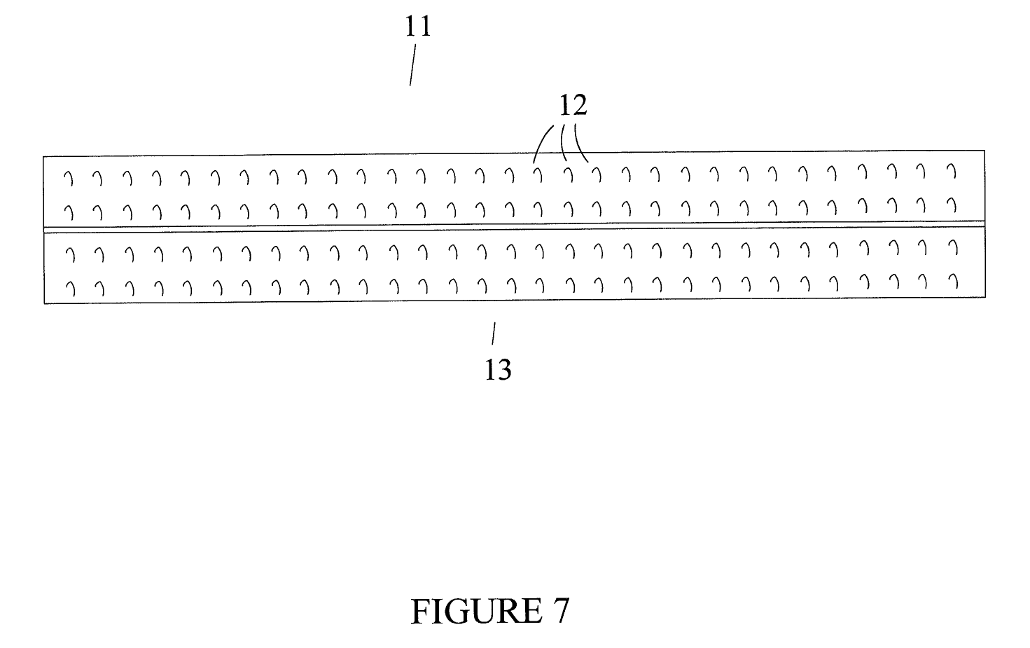

FIG. 7, just the curled center portion would be present, and the hooks located around the outer circumference of curled center portion would be used to anchor the invention to a strip or patch of loop material.

The fastener strip can also be curled “inside out”—i.e., with the fastening elements located on the inside of the tubular wire-retaining channel. The hooks on the uncurled end portions would still be available to anchor the invention to a strip or patch of loop material.

Longer pieces of plastic fastener strip material can be stretched and curled, to form wire looms of greater length than the relatively short looms shown in the figures.

The fastener strip does not have to be extruded from resin. Instead, the fastener strip and the resultant wire loom can be made through any process or from any material having the necessary plasticity—so long as when the fastener strip is stretched, it acquires the inward curl necessary to contain and retain the wire or cable. The fastener strip can also be of any size, shape, or dimension.

A single wire or cable can also be inserted into the loom, rather than the bundle of wires shown in the main embodiment. Thus it can be appreciated that the invention performs a positioning function in addition to its bundling function.

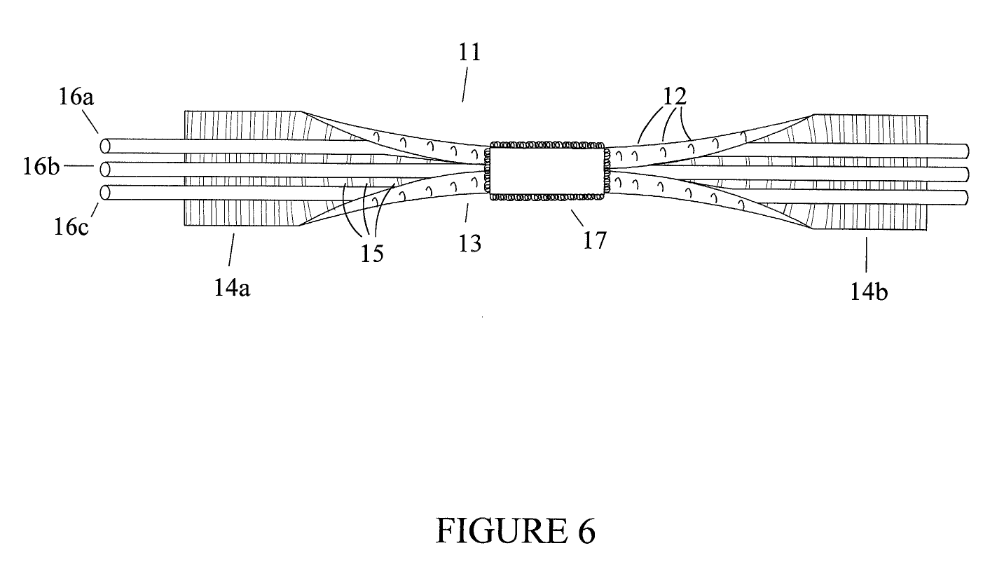

The additional strip of loop material, which provides extra wire-retaining strength, can be eliminated. Alternatively, as illustrated in FIG. 6, the additional strip of loop material can be positioned longitudinally on the wire loom—that is, running down the length of the loom rather than wrapped around its circumference as in the main embodiment.

As shown in the figures, the additional strip of mating material which provides extra wire-retaining strength, and the strip or patch of mating material to which the wire loom can be fastened for wire positioning purposes, can comprise loop material. This loop material can be made by a woven, knitted, non-woven, stitchbond, weft insertion, or any other suitable process. However, material other than loops—such as hook fasteners or other engaging members—may also be used to mate with the fastening elements on the wire loom.

The wire loom can also be made to be flame retardant, magnetically attractable, electrically conductive, or electrically non-conductive to control static charges.

Accordingly, the scope of the invention should be determined not by the embodiments illustrated, but by the appended claims and their legal equivalents.

What is claimed is:

1. A wrap-around sleeve, comprising:
(a) a first side and a second side opposite said first side, and
(b) a tubular channel formed from opposing edges of one said side being in proximate relationship to one another, and
(c) a plurality of fastening elements upstanding from a surface of said tubular channel and extending substantially around a circumference of said tubular channel,
whereby said wrap-around sleeve can accept and retain elongated members.

2. The wrap-around sleeve of claim 1, wherein said fastening elements comprise hook members.

3. The wrap-around sleeve of claim 2, wherein said hook members have a density of between 1 and 2000 hooks per square inch, on said surface of said tubular channel.

4. The wrap-around sleeve of claim 2, wherein said hook members have a height of between 0.1-4.0 millimeters, from said surface of said tubular channel.

5. The wrap-around sleeve of claim 1, wherein said fastening elements extend around an outer circumference of said tubular channel.

6. The wrap-around sleeve of claim 1, wherein said wrap-around sleeve additionally comprises at least one uncurled end portion having a plurality of end portion fastening elements located thereon.

7. The wrap-around sleeve of claim 6, wherein said end portion fastening elements are hook members.

8. The wrap-around sleeve of claim 1, wherein said wrap-around sleeve additionally comprises two uncurled end portions each having a plurality of end portion fastening elements located thereon.

9. The wrap-around sleeve of claim 8, wherein said end portion fastening elements are hook members.

10. The wrap-around sleeve of claim 1, wherein said wrap-around sleeve additionally comprises a strip of loop material extending around an outer circumference of said tubular channel, said loop material engaging with said fastening elements.

11. The wrap-around sleeve of claim 1, wherein said wrap-around sleeve is constructed of plastic resin.

12. A device for holding elongated members, comprising:
(a) a first side and a second side opposite said first side, and
(b) a curled channel formed from opposing edges of one said side being in proximate relationship to one another, and
(c) a plurality of fastening elements upstanding from a surface of said curled channel and integrally formed of one piece with said curled channel,
whereby said device can accept and retain said elongated members.

13. The device of claim 12, wherein said fastening elements comprise hook members.

14. The device of claim 12, wherein said fastening elements extend around an outer circumference of said curled channel.

15. The device of claim 12, wherein said device additionally comprises at least one uncurled end portion having a plurality of end portion fastening elements located thereon.

16. The device of claim 15, wherein said end portion fastening elements are hook members.

17. The device of claim 12, wherein said device additionally comprises two uncurled end portions each having a plurality of end portion fastening elements located thereon.

18. The device of claim 17, wherein said end portion fastening elements are hook members.

19. The device of claim 12, wherein said device additionally comprises a strip of loop material extending around an outer circumference of said curled channel, said loop material engaging with said fastening elements.

20. The device of claim 12, wherein said device is constructed of plastic resin.
